(19) United States
(12) Patent Application Publication
(10) Pub. No.: US 2025/0298816 A1
(43) Pub. Date: Sep. 25, 2025

(54) DOCUMENT QUESTION ANSWERING SYSTEM USING LAYERED LANGUAGE MODELS

(71) Applicant: Counsel AI Corporation, San Francisco, CA (US)

(72) Inventors: Daniel Hunter, San Francisco, CA (US); Elizabeth Lebens, San Francisco, CA (US); Gabriel Pereyra, San Francisco, CA (US); Julio Pereyra, San Francisco, CA (US); Winston Weinberg, San Francisco, CA (US)

(21) Appl. No.: 18/611,498

(22) Filed: Mar. 20, 2024

(51) Int. Cl. G06F 16/332; G06F 16/383

(52) U.S. Cl. CPC G06F 16/3329; G06F 16/3325; G06F 16/383

(57) ABSTRACT

Methods, systems, and apparatus, including computer programs encoded on computer storage media, for using a set of large language models to determine a natural language response to a query. One of the methods includes receiving a query related to a document. The document is submitted to a first model along with a prompt to generate an outline of the document. The document is submitted to a second model along with a prompt to generate metadata of the document. At least a portion of the query, document metadata, and the document outline are submitted to a third model with a prompt to generate a natural language response to the query. A selected sentence from the natural language response is correlated to a document sentence. The natural language response is provided to the user with an indication that the selected sentence from the natural language response is correlated to the document sentence.

### BACKGROUND

### Technical Field

This specification relates to large language models.

### Background

Generative artificial intelligence (AI) approaches can use generative models to generate one or more outputs in response to a query. A generative AI model can learn, for example, from patterns and structures in training data. A trained generative AI model can then generate a response based on learned patterns.

### SUMMARY

This specification describes technologies for generative artificial intelligence. These technologies generally involve using a set of multiple large language models (LLMs) to generate a natural language response regarding, e.g., in response to, a query relevant to a document. Each LLM can be selected for a task or sub-task based on different features or capabilities of the LLM, such as size limits, speed, and/or ability to perform certain types of tasks. An output of one LLM selected for one task may be fed as an input to another LLM that is selected for a next task or sub-task, for eventual generation of the natural language response to the query.

In general, one innovative aspect of the subject matter described in this specification can be embodied in methods that include the actions of: receiving, from a user, a query related to a document; submitting the document to a first large language model along with a first prompt prompting the first large language model to generate an outline of the document; receiving a document outline of the document from the first large language model; submitting the document to a second large language model along with a second prompt prompting the second large language model to generate metadata of the document; receiving document metadata of the document from the second large language model; submitting at least a portion of the query, the document metadata, and the document outline to a third large language model and prompting the third large language model to generate a natural language response to the query based at least in part on the document metadata and the document outline; receiving the natural language response from the third large language model; correlating a selected sentence from the natural language response to a sentence from the document; and providing the natural language response to the user with an indication that the selected sentence from the natural language response is correlated to at least one sentence from the document. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. The document metadata can include a document title, a document date, or information indicating one or more parties party to the document. The second large language model can generate the document metadata based on a predetermined portion of the document. The first prompt can prompt the first large language model to generate a topic aware outline of the document. The document can be submitted to a fourth large language model along with a fourth prompt prompting the fourth large language model to generate a numerical outline of the document. The numerical outline of the document can be received. The numerical outline along with the query, the document metadata, and the topic aware outline can be submitted to the third large language model. The query can be submitted to a fifth large language model along with a fifth prompt prompting the fifth large language model to transform the query into a first outline request for generating the topic aware outline of the document and into a second outline request for generating the numerical outline of the document. The first outline request and the second outline request can be received from the fifth large language model. The first outline request can be included in the first prompt and the second outline request can be included in the fourth prompt. Correlating the selected sentence from the natural language response to a sentence from the document can include submitting relevant document sentences and the selected sentence from the natural language response to a sixth large language model along with a sixth prompt prompting the sixth large language model to rank each relevant document sentence based on relevance of the relevant document sentence to the selected sentence from the natural language response. Relevance of the relevant document sentence to the selected sentence from the natural language response can be determined based on embeddings of the relevant document sentence and of the selected sentence from the natural language response. Determining relevance based on embeddings of the relevant document sentence and of the selected sentence of the natural language response can include determining relevance based on vector distance between embeddings of the relevant document sentence and of the selected sentence. The first large language model, the second large language model, the third large language model, the fourth large language model, the fifth large language model, and the sixth large language model can be selected based on one or more of latency, maximum context window size, accuracy of results, quality of results, or resource usage. A seventh large language model can be used to classify the query into a first query classification of at least two possible query classifications. A seventh prompt can be determined, based on the first query classification, for prompting the third large language model to generate a natural language response to the query based at least in part on the document metadata and the document outline. The seventh prompt can be provided to the third large language model. Two or more of the first large language model, the second large language model, the third large language model, the fourth large language model, the fifth large language model, the sixth large language model, and the seventh large language models can be a same large language model. Two or more of the first large language model, the second large language model, the third large language model, the fourth large language model, the fifth large language model, the sixth large language model, and the seventh large language models can be different large language models. The document can include a plurality of documents.

The subject matter described in this specification can be implemented in particular embodiments so as to realize one or more of the following advantages. An improved document question answering system can provide more accurate results in a lower latency than other solutions by using a combination of large language models. The improved document question answering system can achieve a desired tradeoff between result quality, performance, and other factors by using a selected combination of large language models. In general, the improved document question answering system can provide better (e.g., more accurate) results in lower latency than other solutions by using a combination of, for example, faster and more-targeted (towards specific tasks) large language models and slower, more broadly-capable large language models. The results can be more accurate and more comprehensive than obtained through other approaches including manual solutions, since the automated solution described herein has no incentive to limit results as may occur in manual approaches due to time constraints, fatigue, etc. The improved document question answering system can provide higher quality results than other approaches. For example a response to a user query for a document can include citations that link to selected document sentences that support a natural language response to the user query and the selected document sentences can also be highlighted in the document. The providing of the natural language response along with links to, and highlighting of, selected document sentences can result in user ideation based on the document by sparking user ideas after user review of the citations and the natural language response. In some examples, if the user query specifically asks for quotes from the source document the document question answering system can include, in the natural language response, relevant quotes from the source document.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A illustrates an example environment that includes a document question answering system.

FIG. 1B illustrates an example data flow diagram.

FIG. 2 illustrates an example document question answering system.

FIG. 3 illustrates an example metadata prompt.

FIGS. 4A-4C illustrate example outline requests.

FIG. 5 illustrates an example topical outline prompt.

FIG. 6 illustrates an example numerical outline prompt.

FIG. 7 illustrates an example outline combine prompt.

FIG. 8 illustrates an example table classifier prompt.

FIG. 9 illustrates an example query answer prompt.

FIG. 10 illustrates an example query answer prompt.

FIG. 11 illustrates an example source matching prompt.

FIG. 12 is a flowchart of an example process for using a set of large language models to determine a natural language response to a query.

FIG. 13 is a block diagram illustrating an example computer system used to provide computational functionalities associated with described algorithms, methods, functions, processes, flows, and procedures as described in the present disclosure.

Like reference numbers and designations in the various drawings indicate like elements.

### DETAILED DESCRIPTION

Large language models (LLMs) can be used by users to ask questions, such as questions about an information source, such as a document. However, some LLMs may have capacity or capability restrictions that may make asking the LLM to process the entire document in response to a question either infeasible or unacceptable due to unacceptable result quality. For instance, some LLMs that may be able to process the entire document may not have sufficient intelligence to provide acceptable answers for at least some types of subject matter. As another example, some approaches may use comparison of embeddings of a user query to embeddings of document sentences, which may nor produce meaningful or acceptable results in some cases. Latency may also be an issue with some LLMs, where a LLM may be able to respond to a query but not with acceptable latency, especially for large documents.

To solve these and other issues, an improved document question answering system can use a set of layered LLMs, where different LLMs can be selected and used for different tasks. For instance, some LLMs may be used for low-latency retrieval of content from a document that may be passed, along with the query, to another LLM, which can generate and provide a natural language response to the user query. The LLM that generates the natural language response can thus receive structured data that can guide the LLM in generation of the natural language response. The structured data can provide semantic context for the LLM, such as a document overview and/or document structure relevant to the query, which can result in a more accurate and meaningful answer than may be generated if a single LLM was used to generate an answer based just on the user's query and the document. In general, the different LLMs that are selected, either for intermediate tasks or for generating the natural language response, can be selected based on LLM processing speed, LLM maximum context window, LLM proficiency for certain tasks or types of subject matter, LLM resource usage or cost, or other factors. The exact set or combination of LLMs can be selected to achieve a desired balance of result quality, performance, or cost, for example.

In general, the improved document question answering system can provide accurate results in lower latency than other solutions by using a combination of, for example, faster and more-targeted (towards specific tasks) large language models and slower, more broadly-capable large language models. The improved system can increase a number and type of tasks that can be requested, and received, from a document QA system. For example, the ability of the improved document question answering system to process more complex requests, and return longer and more sophisticated answers, than other systems allows for use cases (such as long-form drafting) that are not possible in other solutions,. In addition and as described in more detail below, with the improved document question answering system, a response to a user query for a document can include selected document sentences that support a natural language response to the user query.

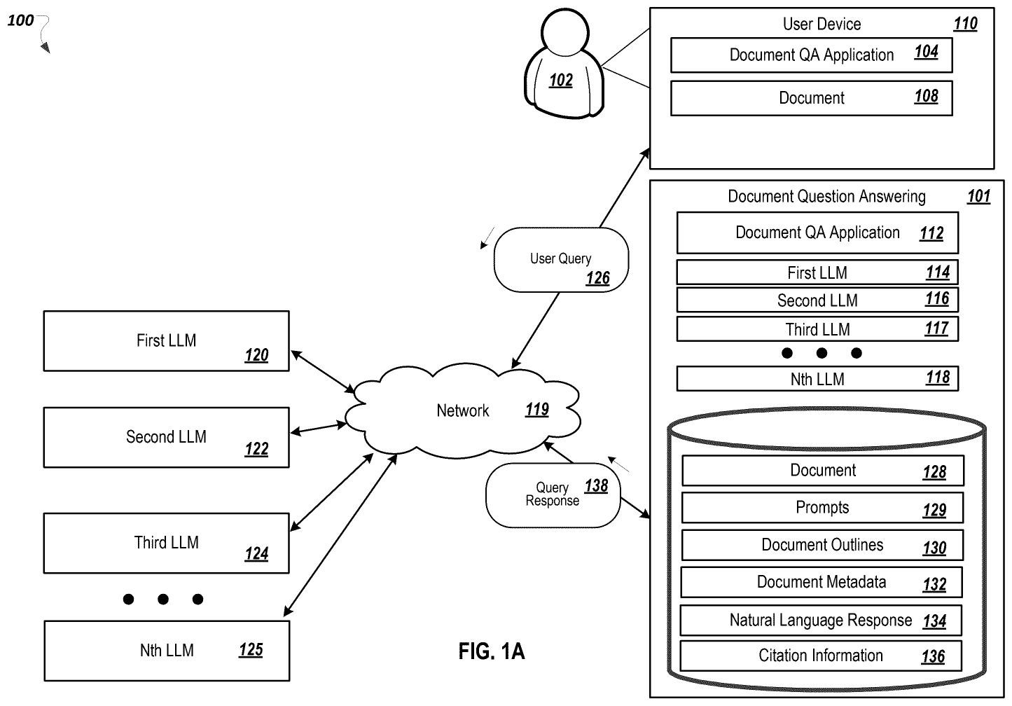

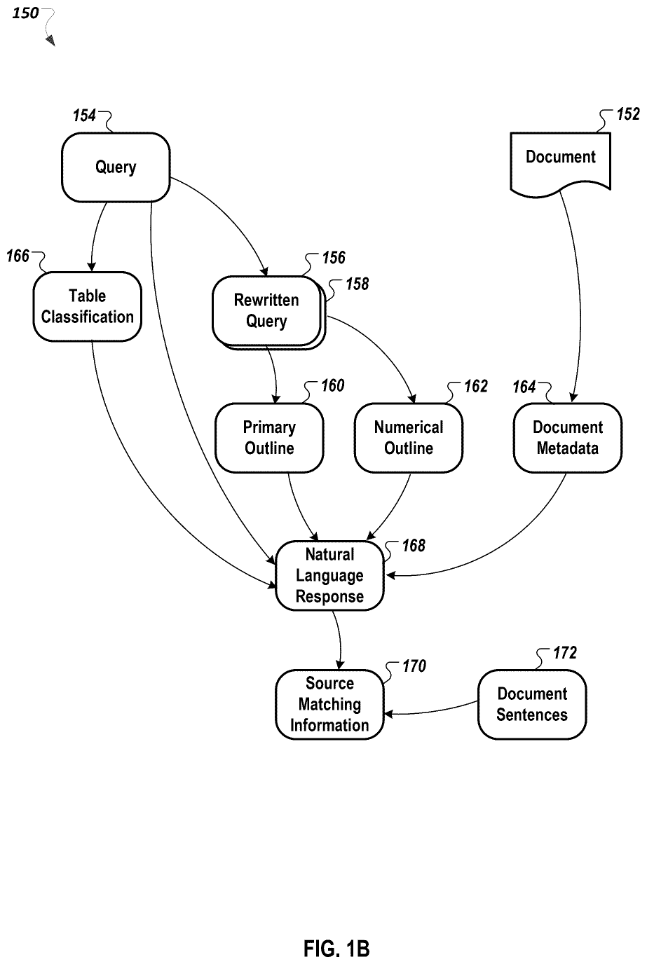

FIG. 1A illustrates an example environment 100 that includes a document question answering system 101. A user 102 can use a document Question Answering (QA) application 104 provided by the document question answering system 101 to obtain answers to questions (e.g., queries) regarding a document 108 or other documents. The document QA application 104 may run locally on a user device 110 of the user 102. In some implementations, the document QA application 104 may be a client-side version of a server-side document QA application 112 that runs on or in the document question answering system 101. The document QA application 104 may be a web application, for example. In other implementations, the document QA application 104 can be a standalone application that the user 102 can download (e.g., from the document question answering system 101 or from another download source).

The document QA application 104 and the document QA application 112 can utilize a set of large language models for determining an answer to a user question. For example, the document question answering system 101 includes a first LLM 114, a second LLM 116, a third LLM 117, and possibly other LLMs (e.g., as represented by an “Nth” LLM 118). In some cases, some or all of the LLMs used by the document question answering system 101 are internal to the document question answering system 101. In other implementations, the document QA application 112 and/or the document QA application 104 can send a request (e.g., over a network 119) to one or more LLMs that are external to the document question answering system 101, such as a first external LLM 120, a second external LLM 122, a third external LLM 124, and possibly other LLMs (e.g., as represented by an “Nth” LLM 125). In some cases, one or more LLMs may be included in the document QA application 104 (e.g., when the document QA application 104 is a standalone application).

As an example when the document question answering system 101 provides a client-server solution, the user device 110 can submit a user query 126 to the document question answering system 101 regarding a document (e.g., an electronic document). In some cases the user query 126 can be included in a request that includes the document (e.g., a copy of the document 108). In other cases, the user query 126 can be included in a request that refers to the document (e.g., using a URL (Uniform Resource Locator) of the document). In some cases, the user query 126 relates to a set of multiple documents. In general, an electronic document, which for brevity will simply be referred to as a document, may, but need not, correspond to a file. A document may be stored in a portion of a file that holds other documents, in a single file dedicated to the document in question, or in multiple coordinated files.

The user query 126 and the document or a reference to the document can be received by the document QA application 112. The document QA application 112 can store the received document, or a document retrieved by the document QA application 112 using a document reference, as a document 128 (e.g., in memory and/or on disk).

The document QA application can interact with various LLMs by providing LLM prompts that may be stored as prompts 129. For example, the document QA application 112 can submit the document 128 to the first LLM 114 along with a first prompt prompting the first LLM 114 to generate an outline of the document. The first LLM 114 can, in response to the first prompt, generate a document outline of the document. The document outline generated by the first LLM 114 can be stored in the document question answering system 101 in document outlines 130. As described in more detail below, the first prompt can include or refer to a rewritten version of the user query 126 that is tailored for an outline generation request. Additionally, the first LLM 114 and/or possibly other LLMs can be prompted to generate different kinds of outlines, such as a topical outline and a numerical outline. Accordingly, the document outlines 130 can include topical outlines, numerical outlines, or other types of outlines.

The document QA application 112 can also submit the document 128 to the second LLM 116 along with a second prompt prompting the second LLM 116 to generate metadata for the document. The second LLM 116 can, in response to the second prompt, generate document metadata, such as a document title, a document date, and information regarding parties that are party to the document. Document metadata generated by the second LLM 116 can be stored in the document question answering system 101 as document metadata 132.

The document QA application 112 can submit the user query 126, the document metadata 132, and the document outlines 130 to the third LLM 117 along with a third prompt prompting the third LLM 117 to generate a natural language response to the user query 126 based at least in part on the document metadata 132 and the document outlines 130. The natural language response generated by the third LLM 117 can be stored in the document question answering system 101 as a natural language response 134.

The document QA application 112 can also generate citation information 136. For example, the document QA application 112 can correlate selected sentence(s) from the natural language response 134 to respective sentence(s) from the document 128. The citation information 136 can include information that indicates that the selected sentence(s) from the natural language response 134 are correlated to the respective sentence(s) from the document 128.

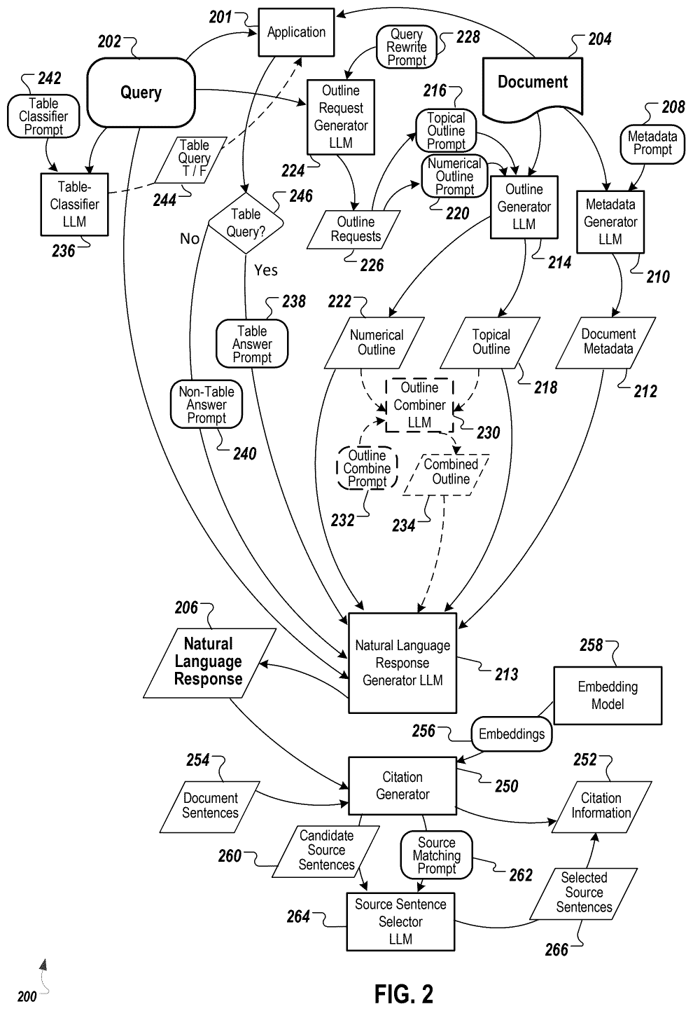

The document QA application 112 can provide the natural language response 134 and the citation information 136 in a query response 138 to the user device 110 in response to the user query 126. The document QA application 104 can display the received natural language response and can highlight the sentences in the document that are correlated to the selected sentences of the natural language response, as indicated in received citation information. Further details regarding citation generation and other details of the document question answering system 101 are described below with respect to FIG. 2.

FIG. 1B illustrates an example data flow diagram 150. A document 152 and a query 154 regarding the document 152 can be received by an application (e.g., the document QA application 112). The query 154 can be rewritten (e.g., using a first LLM) to create a rewritten query 156. The rewritten query 156 can be a version of the query 154 that is expressed as a request to create an outline of the document 152. In some cases, the query 154 is rewritten to form more than one outline request. For example, the rewritten query 156 can be a request to create a topical (e.g., primary) outline of the document 152 and a rewritten query 158 can be generated as a request to create a numerical outline of the document 152. For example, the rewritten query 156 can be used by a second LLM to create a primary outline 160 of the document 152 and the rewritten query 158 can be used by a third LLM to create a numerical outline 162 of the document 152. A fourth LLM can generate document metadata 164 of the document 152.

The primary outline 160, the numerical outline 162, and the document metadata 164 can be provided to a fifth LLM. The fifth LLM can also receive a prompt that can vary based on a table classification 166 that is generated (e.g., by a sixth LLM) based on the query 154. For example, the sixth LLM can determine that the table classification 166 indicates whether the query 154 is requesting a response in a table format. The fifth LLM can generate a natural language response 168 based on the query 154, the primary outline 160, the numerical outline 162, the document metadata 164, and either a prompt that requests the natural language response 168 to be in a table format or a prompt that does not request the natural language response 168 to be in a table format (e.g., based on the table classification 166).

A seventh LLM and possibly one or more embedding models can be used to generate source matching information 170 that indicates which document sentences 172 of the document 152 are correlated to selected sentences in the natural language response 168.

As indicated above and as described below, some or all of the LLMs used to create items in the data flow diagram 150 may be a different LLM. Further details of the use of various LLMs and other processing options are described in more detail below with respect to FIG. 2. FIG. 2 illustrates an example document question answering system 200. The document question answering system 200 can be or can correspond to the document question answering system 101 described above with respect to FIG. 1A. An application 201 (which can be, for example, the document QA application 112 or the document QA application 104) can receive a query 202 for a document 204. To produce a natural language response 206 for the query 202 relevant to the document 204, the application 201 can use a variety of LLMs, as described in more detail below. Each LLM included in the system 200 can be a different LLM that is selected based on one or more factors, such as speed, context window size, capability for certain tasks or certain subject areas, resource use, or other factors. In some implementations, some components that are described as a LLM may perform at least some functionality of the component using technology other than LLM technology. In other implementations, each component described as a LLM uses LLM to implement the functionality of the component. Some different LLMs described below with different names and as generating different outputs may be a same LLM.

The application 201 can provide the document 204 and a metadata prompt 208 to a metadata generator LLM 210. The metadata prompt 208 can prompt the metadata generator LLM 210 to generate document metadata 212 from the document 204. The document metadata 212 can include, for example, a date and title of the document 204 and information regarding parties that are party to the document 204. In some implementations, the metadata prompt 208 prompts the metadata generator LLM 210 to generate the document metadata 212 from a first portion (e.g., a predefined number of tokens, bytes, etc.) of the document 204. The application 201 can provide the document metadata 212 as one of multiple inputs to a natural language response generator LLM 213, as described in more detail below.

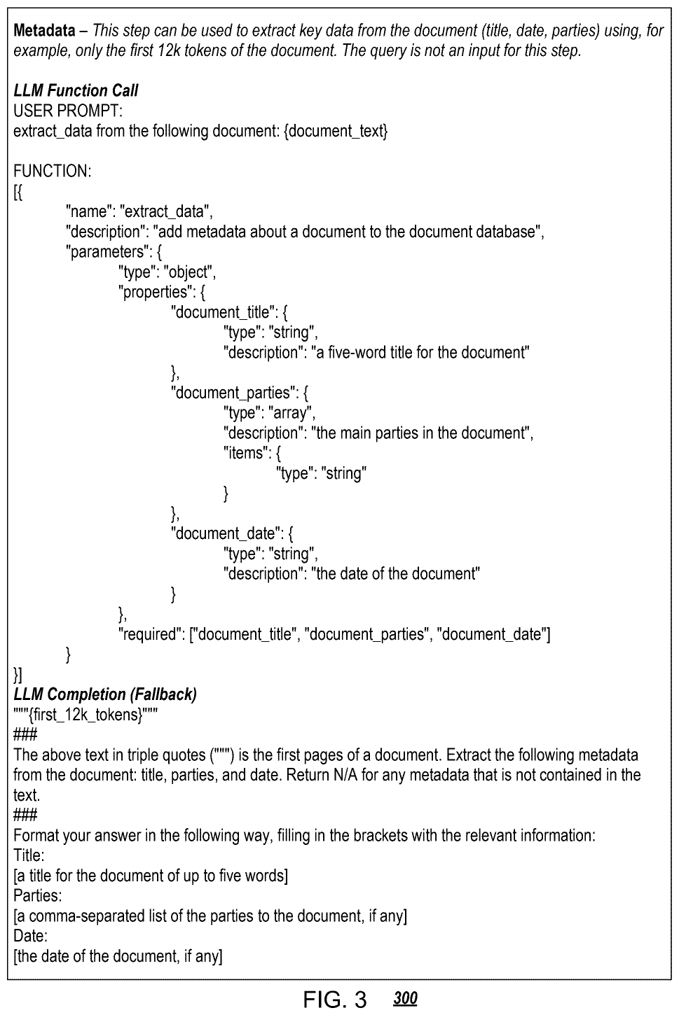

FIG. 3 illustrates an example metadata prompt 300. The example metadata prompt can be provided to the metadata generator LLM 210 described above with respect to FIG. 2 to prompt the metadata generator LLM 210 to generate metadata for a document.

Referring again to FIG. 2, the application 201 can also provide the document 204 to an outline generator LLM 214 for generation of one or more outlines of the document 204. The application 201, for example, can provide a topical outline prompt 216 to the outline generator LLM 214 that prompts the outline generator LLM 214 to generate a topical (e.g., topic-aware) outline 218 of the document 204. The application 201 can also provide a numerical outline prompt 220 to the outline generator LLM 214 that prompts the outline generator LLM 214 to generate a numerical outline 222 of the document 204. Although shown as being generated by a same LLM, in some implementations, different LLMs can be used to generate the topical outline 218 and the numerical outline 222. The topical outline prompt 216 can prompt the outline generator LLM 214 to generate an outline that includes facts from the document that are relevant to topics of the query. The numerical outline prompt 220 can prompt the outline generator LLM 214 to create a numerical outline of numerical values that may be relevant to a topic of the query. The numerical outline can serve as a supplemental outline that outlines numbers from the document 204 that are relevant to the query 202.

In some implementations, the application 201 uses an outline request generator LLM 224 to generate one or more outline requests 226 that are included in the topical outline prompt 216 and/or the numerical outline prompt 220. The outline request generator LLM 224 can, for example, create different outline requests 226 by rewriting the query 202 in a format that is more suitable than the query 202 for requesting generation of the primary topical 218 or the numerical outline 222. The application 201 can include a respective outline request of the generated outline requests 226 in the topical outline prompt 216 or the numerical outline prompt 220. To trigger generation of the outline requests 226, the application 201 can submit a query rewrite prompt 228 and the query 202 to the outline request generator LLM 224 to request generation of the outline requests 226.

The outline generator LLM 214 may be selected, in part, based on having a relatively larger context window than other available LLMs. However, the document 204 may, for some requests, be larger than a maximum context window of the outline generator LLM 214. For such requests, the application 201 can split the document 204 into portions and prompt the outline generator LLM 214 to generate a respective primary outline 218 and a respective numerical outline 222 for each document portion. The application 201 can provide document-portion-related primary outlines and numerical outlines to an outline combiner LLM 230 along with an outline combine prompt 232 that prompts the outline combiner LLM 230 to combine the document-portion-relevant primary outlines and numerical outlines into a combined outline 234.

When the outline combiner LLM 230 is used, the combined outline 234 can be provided as an input to the natural language response generator LLM 213. When the outline combiner LLM 230 is not used (e.g., when the size of the document 204 is not greater than the maximum context window of the outline generator LLM 214) the primary outline 218 and the numerical outline 222 of the document 204 can be provided as inputs to the natural language response generator LLM 213. Accordingly, outline information (e.g., either the primary outline 218 and the numerical outline 222 or the combined outline 234), the document metadata 212, and the query 202 can be provided as inputs to the natural language response generator LLM 213 along with a prompt that prompts the natural language response generator LLM 213 to generate the natural language response 206 as an answer to the query 202.

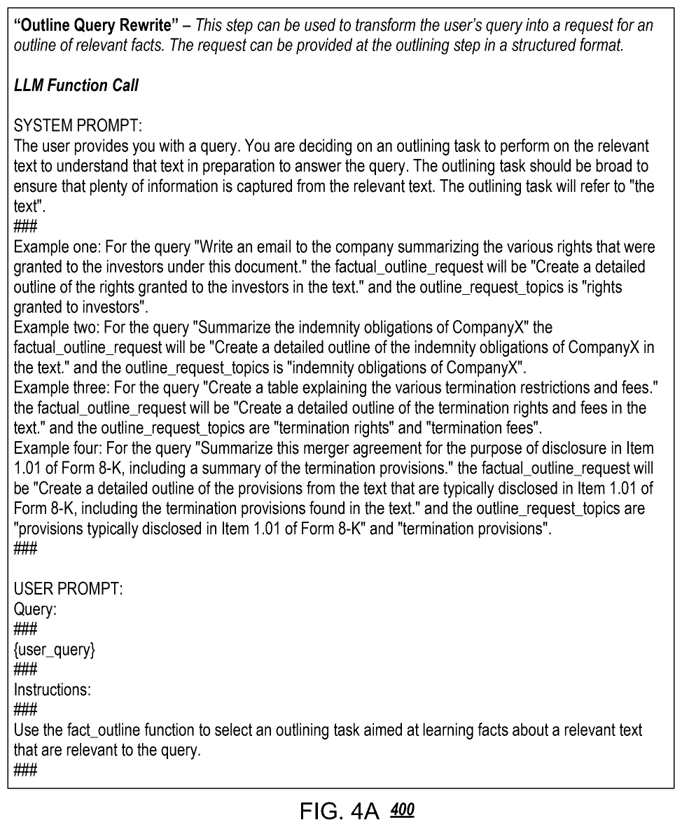

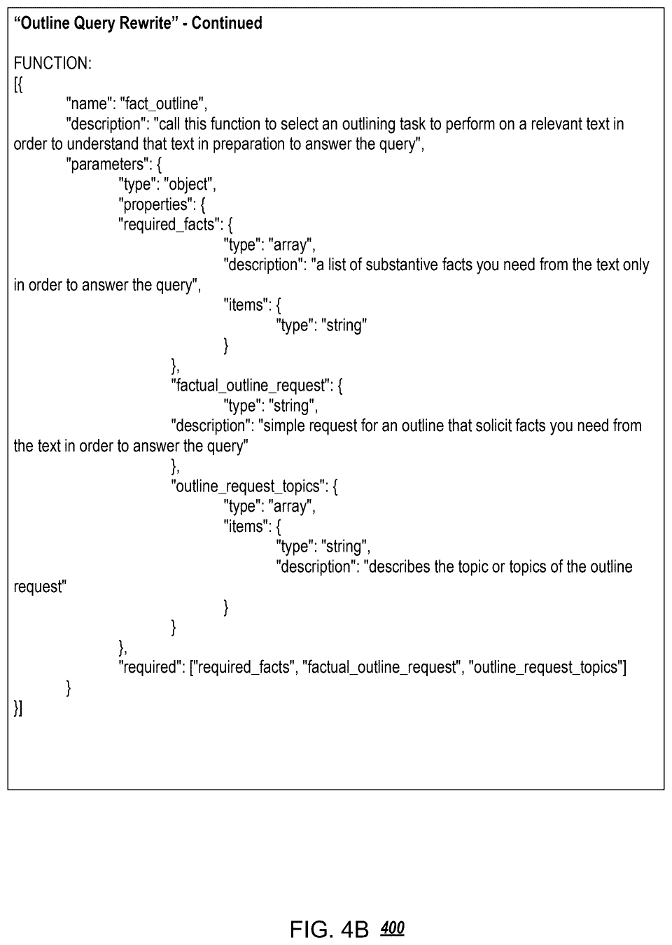

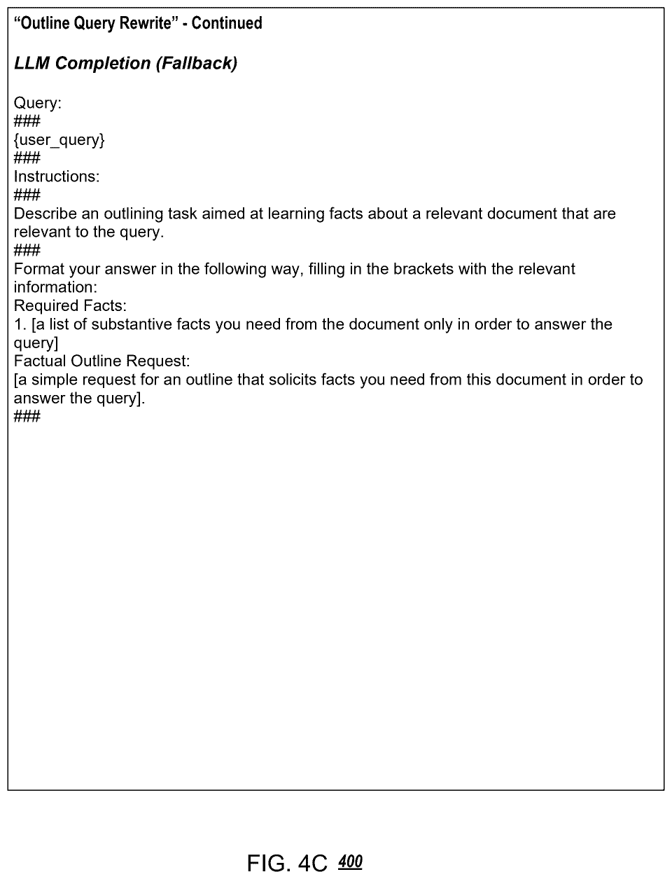

FIGS. 4A-4C illustrate example outline requests 400. The outline requests 400 can be, for example, included in the outline requests 226 described above with respect to FIG. 2. The outline requests can be referred to as “query rewrites” in that the outline requests can be used as prompts to an LLM (e.g., the outline request generator LLM 224) to rewrite a user query as one or more outline generation requests that can be provided to another LLM (e.g., the outline generator LLM 214).

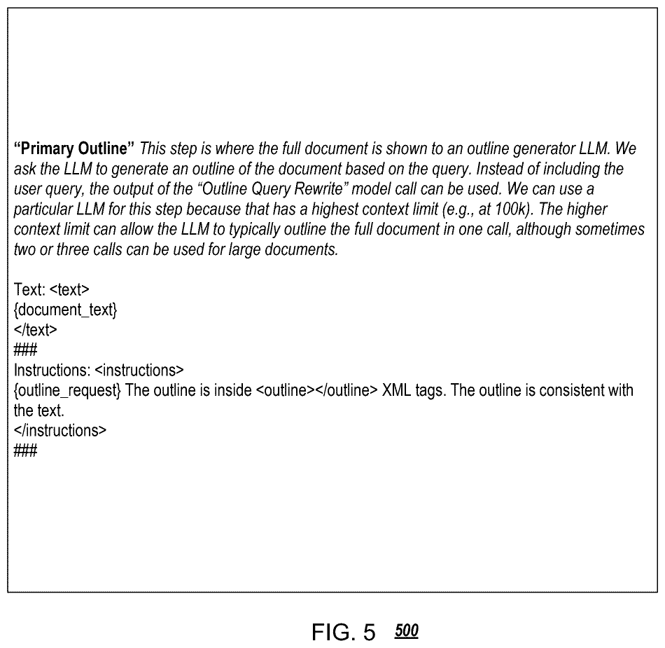

FIG. 5 illustrates an example primary outline prompt 500. The primary outline prompt 500 can be the primary outline prompt 216 described above with respect to FIG. 2. The primary outline prompt 500 includes an outline request generated, for example, by the outline request generator LLM 224 (and corresponding to the outline requests illustrated in FIGS. 4A-4C).

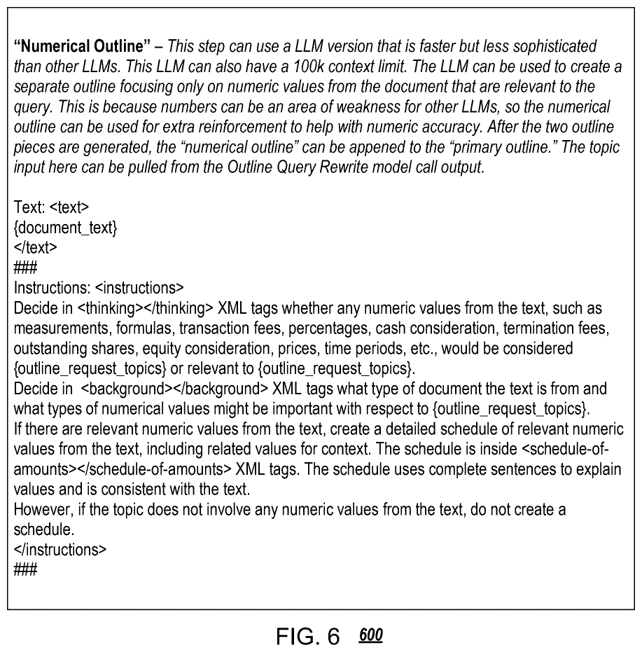

FIG. 6 illustrates an example numerical outline prompt 600. The numerical outline prompt 600 can be the numerical outline prompt 220 described above with respect to FIG. 2. The numerical outline prompt 600 includes an outline request generated, for example, by the outline request generator LLM 224 (and corresponding to the outline requests illustrated in FIGS. 4A-4C).

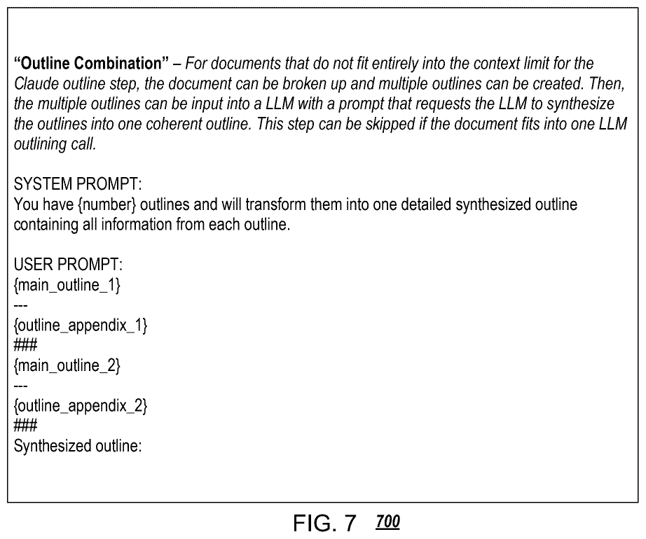

FIG. 7 illustrates an example outline combine prompt 700. The outline combine prompt 700 can be the outline combine prompt 232 described above with respect to FIG. 2. The outline combine prompt 700 can be provided, for example, to the outline combiner LLM 230 to prompt the outline combiner LLM 230 to combine outlines for different document portions such as if an input document was too large to process in one pass.

Referring again to FIG. 2, in some implementations, the application 201 uses a table classifier LLM 236 to determine whether to provide a table answer prompt 238 or a non-table answer prompt 240 as input to the natural language response generator LLM 213. For example, the application 201 can provide the query 202 and a table classifier prompt 242 to the table classifier LLM 236 that prompts the table classifier LLM 236 to generate a table query classification 244 (e.g., true or false) that indicates whether the query 202 is requesting a response in a table format. The application 201 can use the table query classification 244 to determine whether to provide the table answer prompt 238 or the non-table answer prompt 240 to the natural language response generator LLM 213. For example, as illustrated by a decision symbol 246, if the table query classification 244 is true, the application 201 can provide the table answer prompt 238 to the natural language response generator LLM 213, otherwise the application 201 can provide the non-table answer prompt 240 to the natural language response generator LLM 213. The natural language response generator LLM 213 can then generate the natural language response 206 based on the outline information, the query 202, the document metadata 212, and either the table answer prompt 238 or the non-table answer prompt 240.

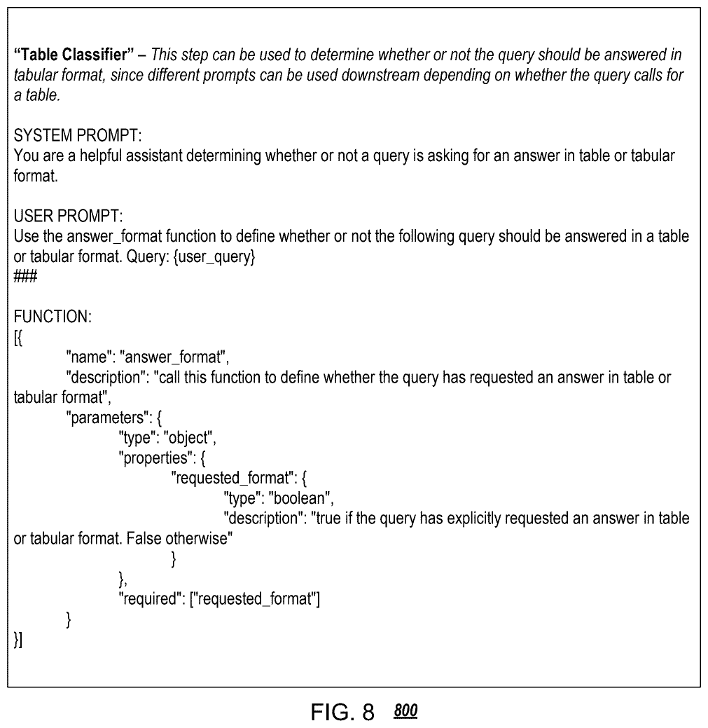

FIG. 8 illustrates an example table classifier prompt 800. The table classifier prompt 800 can be the table classifier prompt 242 described above with respect to FIG. 2. The table classifier prompt 800 can be provided to a LLM (e.g., the table classifier LLM 236) to prompt the LLM to generate a table query classification that indicates whether a query is requesting a response in a table format.

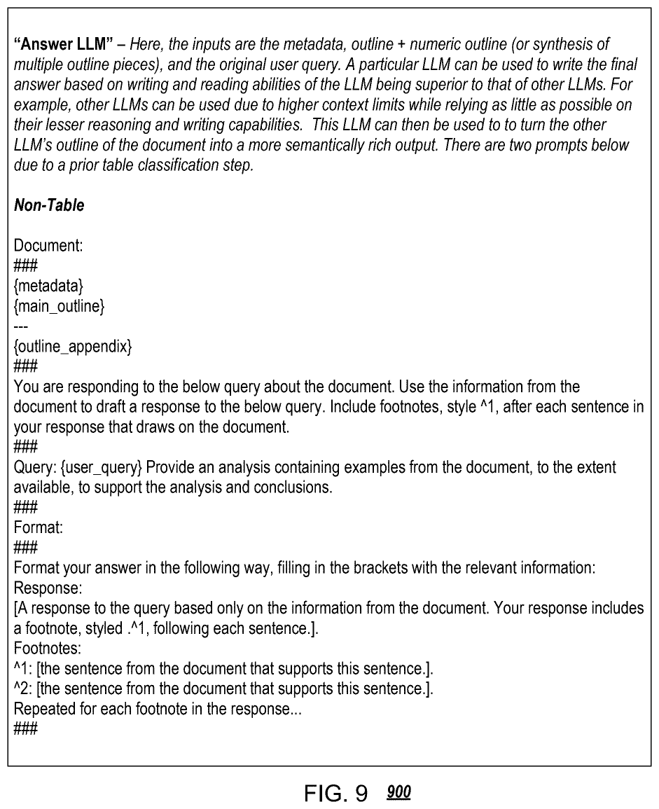

FIG. 9 illustrates an example query answer prompt 900. The query answer prompt 900 can be the non-table answer prompt 240 described above with respect to FIG. 2. The query answer prompt 900 can prompt a LLM (e.g., the natural language response LLM 206) to generate an answer to a query for a document based on document metadata, document outline information, and the query, when the query is not asking for an answer in a table format.

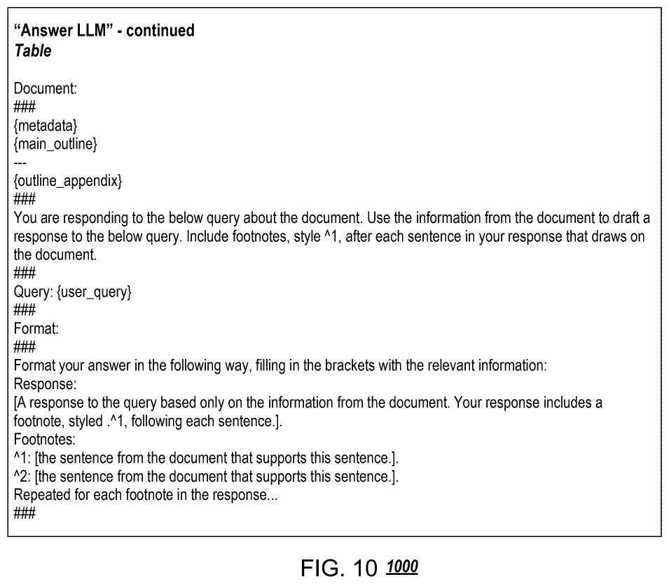

FIG. 10 illustrates an example query answer prompt 1000. The query answer prompt 1000 can be the table answer prompt 238 described above with respect to FIG. 2. The query answer prompt 1000 can prompt a LLM (e.g., the natural language response LLM 206) to generate an answer to a query for a document based on document metadata, document outline information, and the query, when the query is asking for an answer in a table format.

Referring again to FIG. 2, in some implementations, a citation generator 250 can generate citation information 252. The citation information 252 can include information that identifies portions of the document 204 that have been determined to support at least a portion of the natural language response 206. The citation information 252 can be used to highlight information in the document 204 that provides evidentiary support for portions of the natural language response 206, for example. The citation generator 250 can use different approaches when generating the citation information 252 to correlate portions (e.g., sentences, paragraphs) of the natural language response 206 to sentences of the document 204 (which are shown in FIG. 2 as document sentences 254).

In some implementations, the citation generator 250 can identify indicators in the natural language response 206 that indicate which portions of the natural language response 206 can be supported (e.g., linked to evidentiary sources in the document 204). The indicators can be, for example footnote symbols that are placed in the natural language response 206 by the natural language response generator LLM 213. For instance, the table answer prompt 238 and the non-table answer prompt 240 can include instructions that prompt the natural language response generator LLM 213 to put a footnote number (which may be a footnote symbol (e.g., “\hat{ }”) followed by an integer) at the end of each answer portion in the natural language response 206 that was generated by the natural language response generator LLM 213 by drawing or relying on the document 204.

Citations may not be appropriate for some portions of the natural language response 206. For example, one or more introductory sentences in the natural language response 206 may be generated by the natural language response generator LLM 213 without relying on the document 204 and therefore do not need a citation. In some cases, two or more answer sentences in the natural language response 206 may collectively make one statement, and may have one footnote. By identifying the footnotes in the natural language response 206, the citation generator 250 can identify, as supportable answer portions, answer portions that can be supported (e.g., by citations).

The citation generator 250 can compare supportable answer portions to the document sentences 254 to identify candidate supportive document sentences that may best support those answer portions. For example, for each supportable answer portion, the citation generator 250 can compare an embedding of the answer portion to an embedding of each sentence of the document sentences 254. The citation generator 250 can, after the comparing, for each supportable answer portion, rank the document sentences according to highest embedding-comparison match to the answer portion. Embeddings 256 of the answer portion and the document sentences can be obtained from an embedding model 258, for example.

The citation generator 250 can select, for the answer portion, from the ranked document sentences, a predetermined number of highest-ranked document sentences, as candidate source sentences 260 for the answer portion. For example, the citation generator 250 can select forty highest-ranked document sentences, as candidate source sentences 260 for the answer portion.

In some implementations, the citation generator 250 can provide an answer portion, the candidate source sentences 260 for the answer portion, and a source matching prompt 262 to a source sentence selector LLM 264. The source matching prompt 262 can prompt the source sentence selector LLM 264 to select, as selected source sentences 266 for the answer portion, which of the candidate source sentences 260 best support the answer portion. The source sentence selector LLM 264 can be used rather than selecting highest-ranked candidate source sentences from the embedding comparison, for example, based on the source sentence selector LLM 264 generally producing higher quality source sentences than those that may be selected just based on degree of embedding match. In some implementations, if the source sentence selector LLM 264 identifies more than a predetermined number (e.g., four) of selected source sentences 266 for an answer portion, the citation generator 250 can maintain just the predetermined number of selected source sentences 266 for the answer portion and discard other selected source sentences.

The citation generator 250 can include, in the citation information 252, the selected source sentences 266 for each supportable answer portion for which sources sentences have been identified. The citation information 252 can be used by the application 201 when the natural language response 206 is provided to the user in response to the query 202. For example, the natural language response 206 can be displayed to the user (e.g., with footnote information removed or hidden). Each supportable answer portion can be displayed as a selectable link. When a link is selected for an answer portion, the selected source sentences 266 for the answer portion can be highlighted in a displayed copy of the document 204.

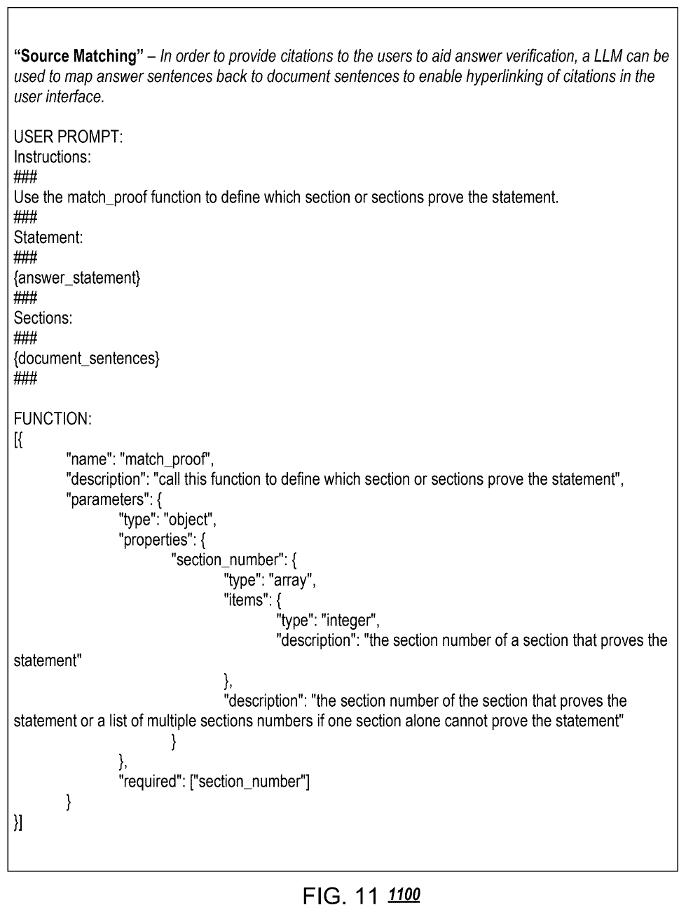

FIG. 11 illustrates an example source matching prompt 1100. The source matching prompt 110 can be the source matching prompt 262 described above with respect to FIG. 2. The source matching prompt 110 can be used to prompt a LLM (e.g., the source sentence selector LLM 264 to select source sentences in a document that support a portion of an answer to a query about the document.

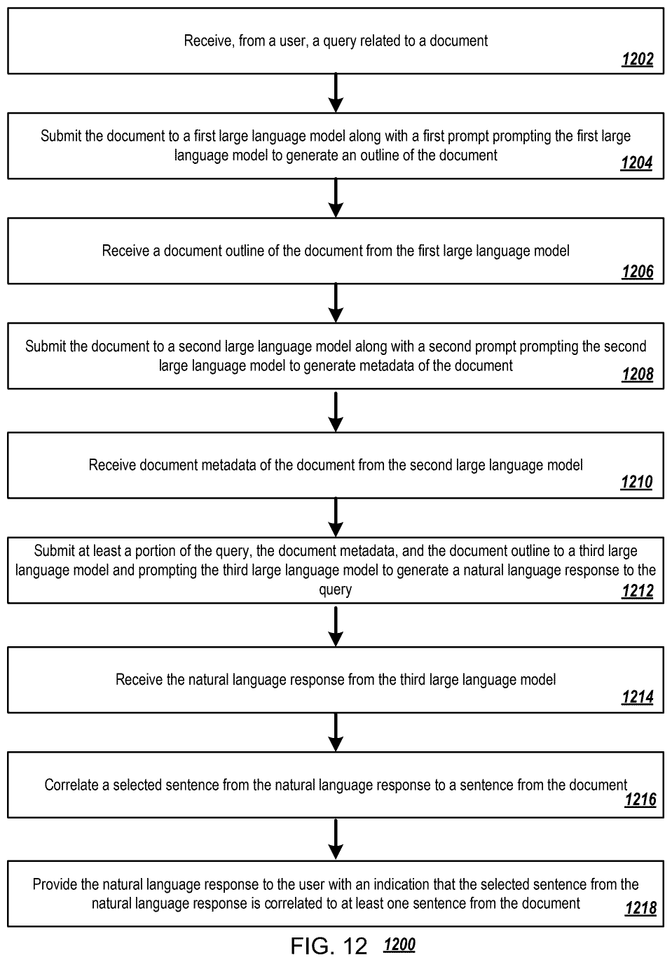

FIG. 12 is a flowchart of an example process 1200 for using a set of large language models to determine a natural language response to a query. For convenience, the process 1200 will be described as being performed by a system of one or more computers, located in one or more locations, and programmed appropriately in accordance with this specification. For example, the application 201, the document QA application 104, or the document QA application 112, appropriately programmed, can perform the process 1200.

At 1202, a user, a query related to a document is received from a user. In some cases, the document is a plurality of documents. The user can provide the document along with the query or can provide a reference (e.g., link) to the document. In some cases, the user uploads the document to a system (e.g., the document question answering system 101) when or before providing the query.

At 1204, the document is submitted to a first large language model along with a first prompt prompting the first large language model to generate an outline of the document. The first prompt can prompt the first large language model to generate a topic aware outline of the document.

At 1206, a document outline of the document is received from the first large language model. The document can also be submitted to a large language model (which can be the first large language model or another model) along with a prompt prompting the large language model to generate a numerical outline of the document. The numerical outline of the document can be received from the large language model. In some cases, a single prompt prompts the first large language model to generate both the topic aware outline of the document and the numerical outline of the document. In some cases, the query and a prompt can be submitted to a large language model where the prompt prompts the large language model to transform the query into a first outline request for generating the topic aware outline of the document and into a second outline request for generating the numerical outline of the document. The first outline request and the second outline request can be included in the first prompt.

At 1208, the document is submitted to a second large language model along with a second prompt prompting the second large language model to generate metadata of the document.

At 1210, document metadata of the document is received from the second large language model. The document metadata can include a document title, a document date, and/or information indicating one or more parties party to the document. The second large language model can generate the document metadata based on a predetermined portion of the document.

At 1212, at least a portion of the query, the document metadata, and the document outline are submitted to a third large language model along with a third prompt that prompts the third large language model to generate a natural language response to the query based at least in part on the document metadata and the document outline. The numerical outline can also be provided to the third large language model. Some of the first large language model, the second large language model, the third large language model, and other large language models that may be used may be the same model or different models. Models may be selected for a certain task based on one or more of smaller latency, higher maximum context window size, higher accuracy of results, higher quality of results, or lower resource usage

At 1214, the natural language response is received from the third large language model.

At 1216, a selected sentence from the natural language response is correlated to a sentence from the document.

At 1218, the natural language response is provided to the user with an indication that the selected sentence from the natural language response is correlated to at least one sentence from the document.

Correlating the selected sentence from the natural language response to the sentence from the document can include: generating a first embedding of the selected sentence from the natural language response; generating a second embedding of each sentence of the document; comparing the first embedding of the selected sentence from the natural language response to each second embedding, to identify candidate source sentences; and selecting, from the candidate source sentences, the sentence of the document, as being correlated to the selected sentence from the natural language response. Selecting, from the candidate source sentences, the sentence of the document, as being correlated to the selected sentence from the natural language response can include: providing the selected sentence from the natural language response, the candidate sources sentences, and a prompt to a large language model, wherein the prompt prompts the large language model to select which of the candidate source sentences are most correlated to the selected sentence from the natural language response. The sentence of the document can be received from the large language model as being one of the candidate source sentences that is most correlated to the selected sentence from the natural language response.

In other words regarding correlating, correlating the selected sentence from the natural language response to a sentence from the document can include submitting relevant document sentences and the selected sentence from the natural language response to a large language model along with a prompt prompting the large language model to rank each relevant document sentence based on relevance of the relevant document sentence to the selected sentence from the natural language response. Relevance of the relevant document sentence to the selected sentence from the natural language response can be determined based on embeddings of the relevant document sentence and of the selected sentence from the natural language response. Determining relevance based on embeddings of the relevant document sentence and of the selected sentence of the natural language response can include determining relevance based on vector distance between embeddings of the relevant document sentence and of the selected sentence.

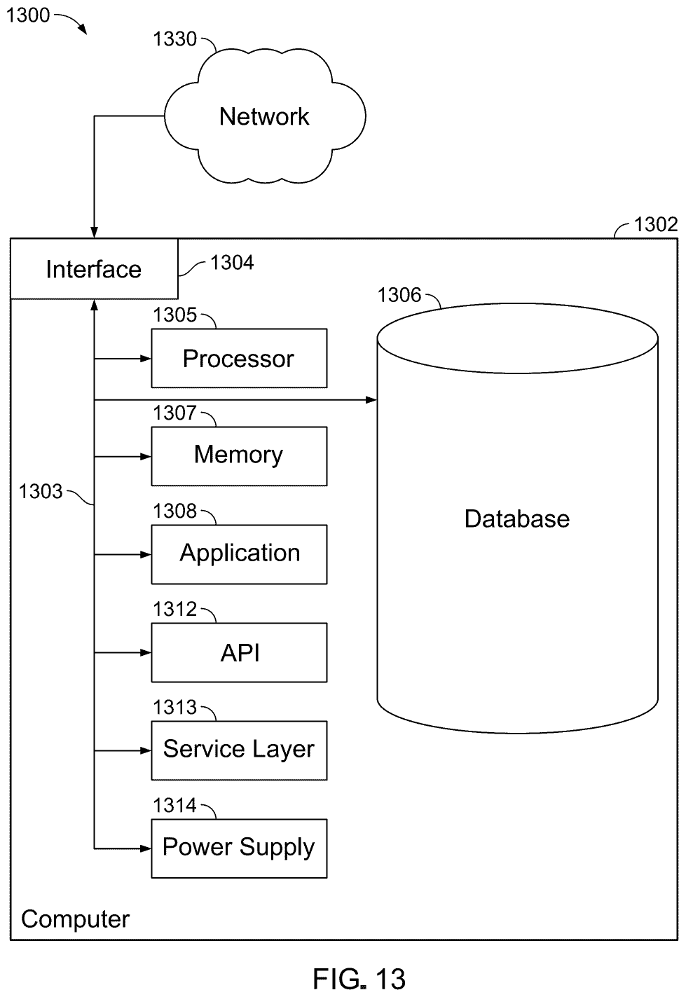

FIG. 13 is a block diagram of an example computer system 1300 used to provide computational functionalities associated with described algorithms, methods, functions, processes, flows, and procedures described in the present disclosure, according to some implementations of the present disclosure. The illustrated computer 1302 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1302 can include input devices such as keypads, keyboards, and touch screens that can accept user information. Also, the computer 1302 can include output devices that can convey information associated with the operation of the computer 1302. The information can include digital data, visual data, audio information, or a combination of information. The information can be presented in a graphical user interface (UI) (or GUI).

The computer 1302 can serve in a role as a client, a network component, a server, a database, a persistency, or components of a computer system for performing the subject matter described in the present disclosure. The illustrated computer 1302 is communicably coupled with a network 1330. In some implementations, one or more components of the computer 1302 can be configured to operate within different environments, including cloud-computing-based environments, local environments, global environments, and combinations of environments.

At a top level, the computer 1302 is an electronic computing device operable to receive, transmit, process, store, and manage data and information associated with the described subject matter. According to some implementations, the computer 1302 can also include, or be communicably coupled with, an application server, an email server, a web server, a caching server, a streaming data server, or a combination of servers.

The computer 1302 can receive requests over network 1330 from a client application (for example, executing on another computer 1302). The computer 1302 can respond to the received requests by processing the received requests using software applications. Requests can also be sent to the computer 1302 from internal users (for example, from a command console), external (or third) parties, automated applications, entities, individuals, systems, and computers.

Each of the components of the computer 1302 can communicate using a system bus 1303. In some implementations, any or all of the components of the computer 1302, including hardware or software components, can interface with each other or the interface 1304 (or a combination of both) over the system bus 1303. Interfaces can use an application programming interface (API) 1312, a service layer 1313, or a combination of the API 1312 and service layer 1313. The API 1312 can include specifications for routines, data structures, and object classes. The API 1312 can be either computer-language independent or dependent. The API 1312 can refer to a complete interface, a single function, or a set of APIs.

The service layer 1313 can provide software services to the computer 1302 and other components (whether illustrated or not) that are communicably coupled to the computer 1302. The functionality of the computer 1302 can be accessible for all service consumers using this service layer. Software services, such as those provided by the service layer 1313, can provide reusable, defined functionalities through a defined interface. For example, the interface can be software written in JAVA, C++, or a language providing data in extensible markup language (XML) format. While illustrated as an integrated component of the computer 1302, in alternative implementations, the API 1312 or the service layer 1313 can be stand-alone components in relation to other components of the computer 1302 and other components communicably coupled to the computer 1302. Moreover, any or all parts of the API 1312 or the service layer 1313 can be implemented as child or sub-modules of another software module, enterprise application, or hardware module without departing from the scope of the present disclosure.

The computer 1302 includes an interface 1304. Although illustrated as a single interface 1304 in FIG. 13, two or more interfaces 1304 can be used according to particular needs, desires, or particular implementations of the computer 1302 and the described functionality. The interface 1304 can be used by the computer 1302 for communicating with other systems that are connected to the network 1330 (whether illustrated or not) in a distributed environment. Generally, the interface 1304 can include, or be implemented using, logic encoded in software or hardware (or a combination of software and hardware) operable to communicate with the network 1330. More specifically, the interface 1304 can include software supporting one or more communication protocols associated with communications. As such, the network 1330 or the interface's hardware can be operable to communicate physical signals within and outside of the illustrated computer 1302.

The computer 1302 includes a processor 1305. Although illustrated as a single processor 1305 in FIG. 13, two or more processors 1305 can be used according to particular needs, desires, or particular implementations of the computer 1302 and the described functionality. Generally, the processor 1305 can execute instructions and can manipulate data to perform the operations of the computer 1302, including operations using algorithms, methods, functions, processes, flows, and procedures as described in the present disclosure.

The computer 1302 also includes a database 1306 that can hold data for the computer 1302 and other components connected to the network 1330 (whether illustrated or not). For example, database 1306 can be an in-memory, conventional, or a database storing data consistent with the present disclosure. In some implementations, database 1306 can be a combination of two or more different database types (for example, hybrid in-memory and conventional databases) according to particular needs, desires, or particular implementations of the computer 1302 and the described functionality. Although illustrated as a single database 1306 in FIG. 13, two or more databases (of the same, different, or combination of types) can be used according to particular needs, desires, or particular implementations of the computer 1302 and the described functionality. While database 1306 is illustrated as an internal component of the computer 1302, in alternative implementations, database 1306 can be external to the computer 1302.

The computer 1302 also includes a memory 1307 that can hold data for the computer 1302 or a combination of components connected to the network 1330 (whether illustrated or not). Memory 1307 can store any data consistent with the present disclosure. In some implementations, memory 1307 can be a combination of two or more different types of memory (for example, a combination of semiconductor and magnetic storage) according to particular needs, desires, or particular implementations of the computer 1302 and the described functionality. Although illustrated as a single memory 1307 in FIG. 13, two or more memories 1307 (of the same, different, or combination of types) can be used according to particular needs, desires, or particular implementations of the computer 1302 and the described functionality. While memory 1307 is illustrated as an internal component of the computer 1302, in alternative implementations, memory 1307 can be external to the computer 1302.

The application 1308 can be an algorithmic software engine providing functionality according to particular needs, desires, or particular implementations of the computer 1302 and the described functionality. For example, application 1308 can serve as one or more components, modules, or applications. Further, although illustrated as a single application 1308, the application 1308 can be implemented as multiple applications 1308 on the computer 1302. In addition, although illustrated as internal to the computer 1302, in alternative implementations, the application 1308 can be external to the computer 1302.

The computer 1302 can also include a power supply 1314. The power supply 1314 can include a rechargeable or non-rechargeable battery that can be configured to be either user-or non-user-replaceable. In some implementations, the power supply 1314 can include power-conversion and management circuits, including recharging, standby, and power management functionalities. In some implementations, the power-supply 1314 can include a power plug to allow the computer 1302 to be plugged into a wall socket or a power source to, for example, power the computer 1302 or recharge a rechargeable battery.

There can be any number of computers 1302 associated with, or external to, a computer system containing computer 1302, with each computer 1302 communicating over network 1330. Further, the terms “client,” “user,” and other appropriate terminology can be used interchangeably, as appropriate, without departing from the scope of the present disclosure. Moreover, the present disclosure contemplates that many users can use one computer 1302 and one user can use multiple computers 1302.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine- readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving, from a user, a query related to a document;
submitting the document to a first large language model along with a first prompt prompting the first large language model to generate an outline of the document;
receiving a document outline of the document from the first large language model;
submitting the document to a second large language model along with a second prompt prompting the second large language model to generate metadata of the document;
receiving document metadata of the document from the second large language model;
submitting at least a portion of the query, the document metadata, and the document outline to a third large language model and prompting the third large language model to generate a natural language response to the query based at least in part on the document metadata and the document outline;
receiving the natural language response from the third large language model;
augmenting the natural language response generated by the third language model with one or more citations to one or more specific supporting sentences from the document that provide support for a target sentence in the natural language response, comprising:
determining a collection of candidate document sentences based on comparisons of: (i) respective embeddings of each of a plurality of sentences from the document, and (ii) an embedding of the target sentence from the natural language response;
submitting the collection of candidate document sentences and the target sentence from the natural language response to a fourth large language model along with a fourth prompt prompting the fourth large language model to generate, as an output of the fourth large language model, a ranking of the collection of candidate document sentences based on a respective relevance of each of the candidate document sentences to the target sentence from the natural language response;
selecting one or more of the candidate document sentences as specific supporting sentences from the document that provide support for the target sentence from the natural language response based on the ranking generated using the fourth large language model; and
augmenting the natural language response generated by the third language model with one or more citations to the specific supporting sentences from the document that provide support for the target sentence from the natural language response; and
outputting the natural language response with the one or more citations to the one or more specific supporting sentences from the document.

2. The method of claim 1, wherein the document metadata comprises a document title, a document date, or information indicating one or more parties party to the document.

3. The method of claim 1, wherein the second large language model generates the document metadata based on a predetermined portion of the document.

4. The method of claim 1, wherein the first prompt prompts the first large language model to generate, as the outline of the document, a topic aware outline of the document.

5. The method of claim 4, further comprising:
submitting the document to a fifth large language model along with a fifth prompt prompting the fifth large language model to generate a numerical outline of the document;
receiving the numerical outline of the document; and
submitting the numerical outline along with the query, the document metadata, and the topic aware outline to the third large language model.

6. The method of claim 5, further comprising:
submitting the query to a sixth large language model along with a sixth prompt prompting the sixth large language model to transform the query into a first outline request for generating the topic aware outline of the document and into a second outline request for generating the numerical outline of the document;
receiving the first outline request and the second outline request from the sixth large language model; and
including the first outline request in the first prompt; and
including the second outline request in the fifth prompt.

7. (canceled)

8. (canceled)

9. The method of claim 1, wherein determining a collection of candidate document sentences based on comparisons of: (i) respective embeddings of each of a plurality of sentences from the document, and (ii) an embedding of the target sentence of the natural language response comprises:
determining relevance based on vector distance between embeddings of document sentences and of the target sentence.

10. The method of claim 6, wherein the first large language model, the second large language model, the third large language model, the fourth large language model, the fifth large language model, and the sixth large language model are selected based on one or more of latency, maximum context window size, accuracy of results, quality of results, or resource usage.

11. The method of claim 1, further comprising;
using a seventh large language model to classify the query into a first query classification of at least two possible query classifications; and
determining a seventh prompt, based on the first query classification, for prompting the third large language model to generate a natural language response to the query based at least in part on the document metadata and the document outline; and
providing the seventh prompt to the third large language model.

12. The method of claim 11, wherein two or more of the first large language model, the second large language model, the third large language model, the fourth large language model, the fifth large language model, the sixth large language model, and the seventh large language model are a same large language model.

13. The method of claim 11, wherein two or more of the first large language model, the second large language model, the third large language model, the fourth large language model, the fifth large language model, the sixth large language model, and the seventh large language model are different large language models.

14. The method of claim 1, wherein the document is a plurality of documents.

15. One or more non-transitory computer-readable storage media encoded with instructions that, when executed by one or more computers, cause the one or more computers to perform operations comprising:
receiving, from a user, a query related to a document;
submitting the document to a first large language model along with a first prompt prompting the first large language model to generate an outline of the document;
receiving a document outline of the document from the first large language model;
submitting the document to a second large language model along with a second prompt prompting the second large language model to generate metadata of the document;
receiving document metadata of the document from the second large language model;
submitting at least a portion of the query, the document metadata, and the document outline to a third large language model and prompting the third large language model to generate a natural language response to the query based at least in part on the document metadata and the document outline;
receiving the natural language response from the third large language model;
augmenting the natural language response generated by the third language model with one or more citations to one or more specific supporting sentences from the document that provide support for a target sentence in the natural language response, comprising:
determining a collection of candidate document sentences based on comparisons of: (i) respective embeddings of each of a plurality of sentences from the document, and (ii) an embedding of the target sentence from the natural language response;
submitting the collection of candidate document sentences and the target sentence from the natural language response to a fourth large language model along with a fourth prompt prompting the fourth large language model to generate, as an output of the fourth large language model, a ranking of the collection of candidate document sentences based on a respective relevance of each of the candidate document sentences to the target sentence from the natural language response;
selecting one or more of the candidate document sentences as specific supporting sentences from the document that provide support for the target sentence from the natural language response based on the ranking generated using the fourth large language model; and
augmenting the natural language response generated by the third language model with one or more citations to the specific supporting sentences from the document that provide support for the target sentence from the natural language response; and
outputting the natural language response with the one or more citations to the one or more specific supporting sentences from the document.

16. The computer-readable storage media of claim 15, wherein the document metadata comprises a document title, a document date, or information indicating one or more parties party to the document.

17. The computer-readable storage media of claim 15, wherein the second large language model generates the document metadata based on a predetermined portion of the document.

18. A system comprising:
one or more computers and one or more storage devices on which are stored instructions that are operable, when executed by the one or more computers, to cause the one or more computers to perform operations comprising:
receiving, from a user, a query related to a document;
submitting the document to a first large language model along with a first prompt prompting the first large language model to generate an outline of the document;
receiving a document outline of the document from the first large language model;
submitting the document to a second large language model along with a second prompt prompting the second large language model to generate metadata of the document;
receiving document metadata of the document from the second large language model;
submitting at least a portion of the query, the document metadata, and the document outline to a third large language model and prompting the third large language model to generate a natural language response to the query based at least in part on the document metadata and the document outline;
receiving the natural language response from the third large language model;
augmenting the natural language response generated by the third language model with one or more citations to one or more specific supporting sentences from the document that provide support for a target sentence in the natural language response, comprising:
determining a collection of candidate document sentences based on comparisons of: (i) respective embeddings of each of a plurality of sentences from the document, and (ii) an embedding of the target sentence from the natural language response;
submitting the collection of candidate document sentences and the target sentence from the natural language response to a fourth large language model along with a fourth prompt prompting the fourth large language model to generate, as an output of the fourth large language model, a ranking of the collection of candidate document sentences based on a respective relevance of each of the candidate document sentences to the target sentence from the natural language response;
selecting one or more of the candidate document sentences as specific supporting sentences from the document that provide support for the target sentence from the natural language response based on the ranking generated using the fourth large language model; and
augmenting the natural language response generated by the third language model with one or more citations to the specific supporting sentences from the document that provide support for the target sentence from the natural language response; and
outputting the natural language response with the one or more citations to the one or more specific supporting sentences from the document.

19. The system of claim 18, wherein the document metadata comprises a document title, a document date, or information indicating one or more parties party to the document.

20. The system of claim 18, wherein the second large language model generates the document metadata based on a predetermined portion of the document.

21. The method of claim 1, wherein the specific sentences from the document comprise less than ten sentences.

22. The method of claim 1, wherein the specific sentences from the document comprise less than five sentences.

23. The method of claim 1, wherein the specific sentences from the document comprise less than three sentences.
